(19) United States
(12) Patent Application Publication
(10) Pub. No.: US 2014/0354413 A1
(43) Pub. Date: Dec. 4, 2014

(54) CHARGE-PUMP CIRCUIT FOR IMPROVING READ DISTANCE

(71) Applicants: Pairote Sirinamarattana, Nonthaburi (TH); Karn Opasjumruskit, Nonthaburi (TH)

(72) Inventors: Pairote Sirinamarattana, Nonthaburi (TH); Karn Opasjumruskit, Nonthaburi (TH)

(73) Assignee: SILICON CRAFT TECHNOLOGY CO., LTD., Bangkok (TH)

(21) Appl. No.: 14/344,323

(22) PCT Filed: Sep. 13, 2011
(86) PCT No.: PCT/IB2011/002758

§ 371 Date: Mar. 12, 2014

(51) Int. Cl. G06K 19/073; G06K 7/10; G06K 19/07

(52) U.S. Cl. CPC G06K 19/073; G06K 19/0723; G06K 7/10009
USPC 340/10.3; 235/492

(57) ABSTRACT

A system and method for improving the read distance of a transponder. The transponder comprises an antenna receiving energy from an interrogation signal, a resonant capacitor coupling with the antenna to form a tuned circuit, a charge-pump circuit to multiply voltage derived from the tuned circuit and a storage capacitor to store the voltage which has been multiplied by the charge-pump circuit.

### FIELD OF THE INVENTION

The present invention relates generally to circuits, devices, systems and methods for communicating in communication systems.

### BACKGROUND

In recent years, RFID (radio frequency identification) technology is widely used in many applications. It is implemented on various frequencies. Ultra high frequency (UHF) is implemented at 868 MHz, 915 MHz, 2.45 GHz and 5.8 GHz. High frequency (HF) technology is implemented at 13.56 MHz. Low frequency (LF) technology is implemented around 100 kHz-150 kHz. For LF RFID, the most widely adopted RFID standards are full-duplex systems (FDX) and half-duplex systems (HDX).

Conventional HDX systems comprise at least one RFID reader and one RFID transponder. Most of the transponders are “passive communication devices”, which do not utilize a battery. They receive sufficient energy originated from a nearby RFID reader to activate themselves. Their advantages are smaller device size and no battery charging or battery replacing requirement. However, their disadvantage is short communication range, which is typically less than 1.5 meters. There is therefore a need for HDX systems that do not increase the transponder size or cost, but have a longer communication or read range.

### SUMMARY

Conventional charging circuits use the voltage from a tuned circuit to charge a storage capacitor and use the stored voltage in the storage capacitor to maintain the oscillation of the tuned circuit after an interrogation signal from a RFID reader is gone. This stored voltage in the storage capacitor governs the amplitude of the response signal; therefore the transmission power is limited.

The present invention extends the communication range between a reader and a transponder by including a charge-pump circuit in the transponder's microchip to increase the charged voltage above a level that is normally charged by the tuned circuit alone. This is achieved by adding a comparably small circuit to the transponder without increasing the transponder cost, transponder size or overall communication system cost.

Moreover, if the first charging phase does not retrieve sufficient energy, the transponder can decide to not transmit and wait for the next charging phase to charge more energy until the energy reaches a sufficient level. Usually the transponder is optimally designed such that within one-cycle, it will be charged to a level quite close to the steady state level; however the charge-pump circuit allows the charging to continue thus increasing the stored voltage sufficiently within a few more cycles.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

FIG. 1 shows an exemplary embodiment of a charging circuit in accordance with the present invention;

FIGS. 2a-c show exemplary embodiments of components in the exemplary charging circuit and also example waveforms of the exemplary charging circuit;

FIG. 3 shows simulated waveforms comparing the voltage across a storage capacitor with or without the charge-pump circuit in accordance with the present invention;

FIG. 4 shows a diagram that illustrates the concept of a multi-cycle charge-pump scheme; and

FIG. 5 shows simulated waveforms comparing the voltage across a storage capacitor with or without the exemplary charge-pump circuit after 4 charging cycles.

### DETAILED DESCRIPTION

Charging circuits generally consist of a reader and a transponder. When the reader supplies electromagnetic energy, a LC tank of the transponder receives the energy and charges the energy to a storage capacitor. The LC tank comprises an antenna coil (L₁), in parallel with a resonance capacitor (C₁) and the relationship of L₁ and C₁ to a selective frequency (f_{c}) is f_{c}=½π\sqrt{L₁C₁}.

The antenna coil L₁ is used to receive electromagnetic energy from the reader and transmit the electromagnetic data to the reader or to another RFID receiver. The resonance capacitor C₁ should match with the antenna coil L₁ in frequency for optimum electromagnetic energy receipt and transmittal at a selective frequency.

In HDX transmission, the transponder transmission power depends largely on the amplitude of a carrier wave which is proportional to the voltage stored on the storage capacitor. The higher the voltage on the storage capacitor, the larger the amplitude of the carrier wave that is produced, thereby making the voltage on the receiver bigger. Therefore, the transponder that transmits with a larger voltage will have a longer read range.

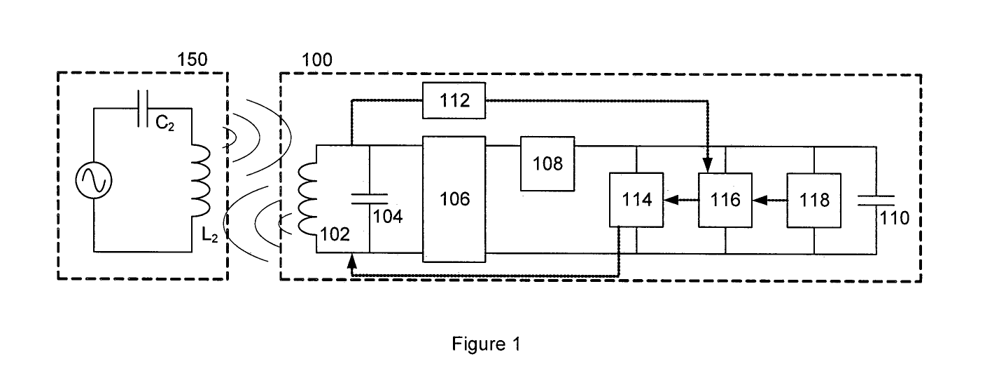

FIG. 1 shows an exemplary embodiment according to the present invention. As shown, a HDX transponder 100 comprises an antenna 102, which receives an interrogation signal from a RFID reader 150, and a resonant capacitor 104, which stores energy received by antenna 102; antenna 102 and capacitor 104 being coupled in parallel thereby forming a tuned circuit. In addition, a rectifying device 106 (which may comprise of but is not limited to a half-wave rectifier or a full-wave rectifier) may be coupled to the tuned circuit to extract a usable positive voltage from an AC signal across the tuned circuit. The positive voltage is further multiplied by a charge-pump circuit 108 and then smoothened and stored by a storage capacitor 110.

In an alternative embodiment, the rectifying device 106 may be omitted and the charge pump circuit 108 may multiply voltage derived directly from the tuned circuit. The multiplied voltage is similarly smoothened and stored by storage capacitor 110. Storage capacitor 110 stores energy received from reader 150 during the charging phase. This energy charging time is usually around 20 ms-150 ms. In the response phase, reader 150 stops its RF energy transmission and waits for a response from transponder 100.

Transponder 100 may respond by sending its unique ID (binary data) to reader 150 by FSK (Frequency-Shift Keying) modulation, which has a bit ‘0’ at around 134.2 kHz and a bit ‘1’ at around 124.2 kHz. In another embodiment, other selections of frequencies representing bit ‘0’ and ‘1’ may be used instead. Similarly, in other embodiments, the transponder may not limited to FSK modulation, but may also respond by ASK (Amplitude-Shift Keying) and PSK (Phase-Shift Keying) modulation to the reader.

Transponder 100 may also comprise an end-of-burst detector 112 which detects the moment when the RFID reader stops the interrogation signal initiating the response phase. In the response phase, transponder 100 uses energy previously stored in storage capacitor 110 to supply energy to oscillator 114, modulation control circuit 116, and memory 118 to generate a RF response signal representing identification data.

After RFID reader 150 stops its interrogation signal, the oscillation on the tuned circuit will usually gradually die down due to power loss. In the present invention, the oscillator 114 compensates for this loss to maintain the oscillation by drawing stored power from storage capacitor 110 and adding it to the tuned circuit. The maximum amplitude of oscillation is directly proportional to the stored voltage. Hence, the higher the stored voltage is, the bigger the amplitude of the oscillation will be, and therefore the better the transmission distance.

In addition to maintaining the oscillation, oscillator 114 can also adjusts its amplitude, phase or frequency according to input data from the modulation control circuit 116 to generate ASK, PSK or FSK encoded RF signal respectively. The modulation control circuit 116 reads the identification data stored in memory 118 and encode those data to be suitable for RF transmission.

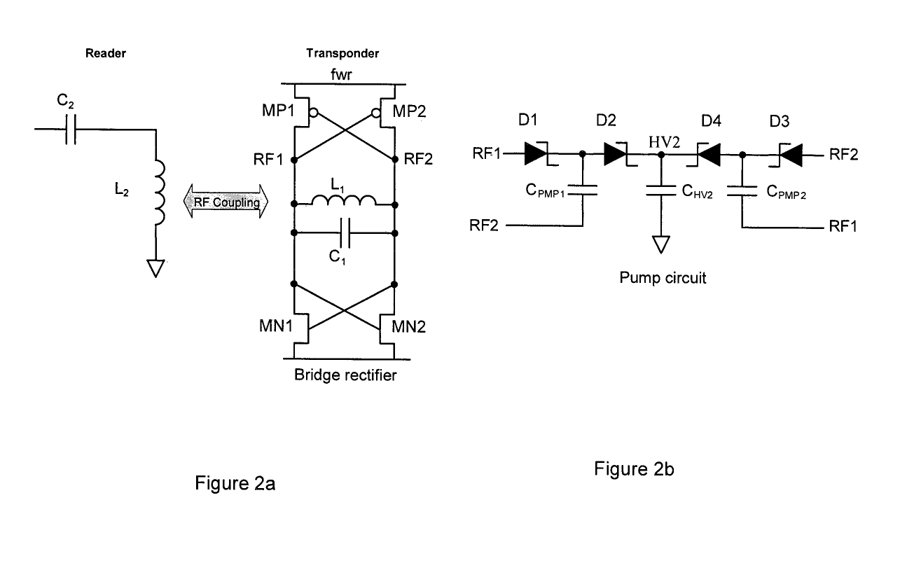

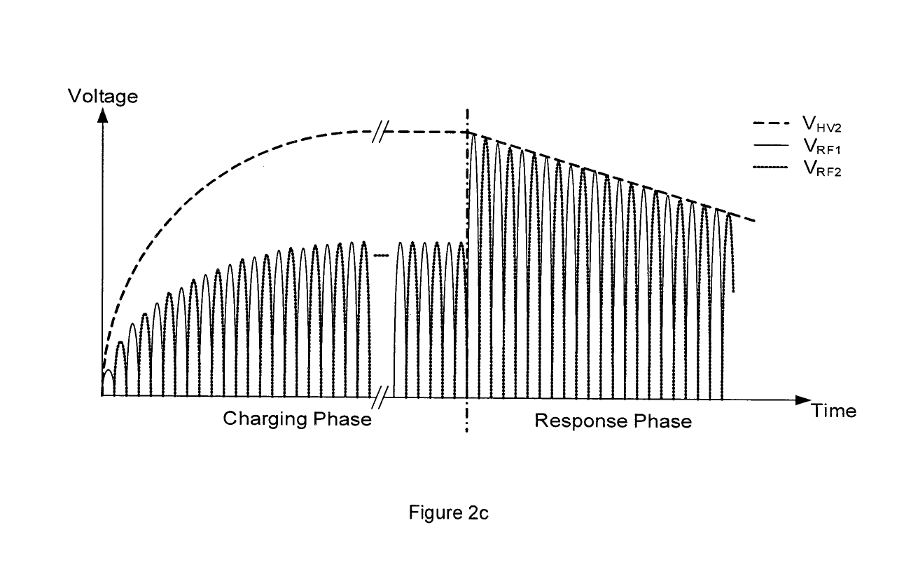

FIG. 2a shows an example where the rectifying device 106 comprises a full wave rectifier. As shown, the first terminal RF1 of the tuned circuit is connected to the drain terminal of a complimentary pair of transistors MN1 and MP1. The second terminal RF2 is connected to the drain terminal of another pair of transistors MN2 and MP2. The gate terminal of transistors MN1 and MP1 are connected to the drain terminal of transistors MN2 and MP2 and vice versa.

FIG. 2b shows an example embodiment of a charge-pump circuit 108 (as shown in FIG. 1) using the RF1 and RF2 voltage as inputs. When the signal RF1 has higher voltage than the signal RF2, the charge is transferred through the first diode D1 thereby creating positive voltage drop across the first pump capacitor CPMP1. During this period, if the voltage across the capacitor CPMP 1 is larger than the voltage across the capacitor CHV2, then the charge is further transferred from the capacitor CPMP1 to CHV2 through the second diode D2. The charge transfer stops when the signal RF1 isn't high enough to forward bias the first diode D1 (especially when it decreases), at which point, the charge sharing between the capacitors CPMP1 and CHV2 reaches equilibrium.

When the signal RF2 has higher voltage than the signal RF1, the first diode D1 is reverse biased. However, the voltage at the anode of the second diode D2 is further increased because the signal RF2 is driving the bottom terminal of the capacitor CPMP 1 up. The raised voltage transfers more charge into capacitor CHV2 until it reaches equilibrium. When the signal RF2 decreases, the second diode D2 is reversed biased without current flow, therefore the transferred charge is kept on the capacitor CHV2. As the signals RF1 and RF2 continue to alternately go high and low, the charge on capacitor CHV2 will keep increasing.

Using the common source terminal of the transistors MN1 and MN2 as a ground reference, the waveforms of the voltages RF1, RF2 are as shown in FIG. 2c. As can be seen, with RF1 and RF2 alternating between high and low, the voltage across the capacitor is constantly kept high. This voltage is used by oscillator 114 to generate response signals with greater amplitude as compared to conventional circuits, thereby ensuring a better read distance of the transponder, the improvement in read distant ranging from about 10-30%. The steady state of the voltage across the capacitor CHV2 is reached when the voltage is equal to the sum of the maximum voltage across the capacitor CPMP1 and the maximum voltage of the signal RF2 minus the voltage drop across the second diode D2. The voltage across the capacitor CPMP1 is equal to the maximum voltage of the signal RF1 minuses the voltage drop across the first diode D1.

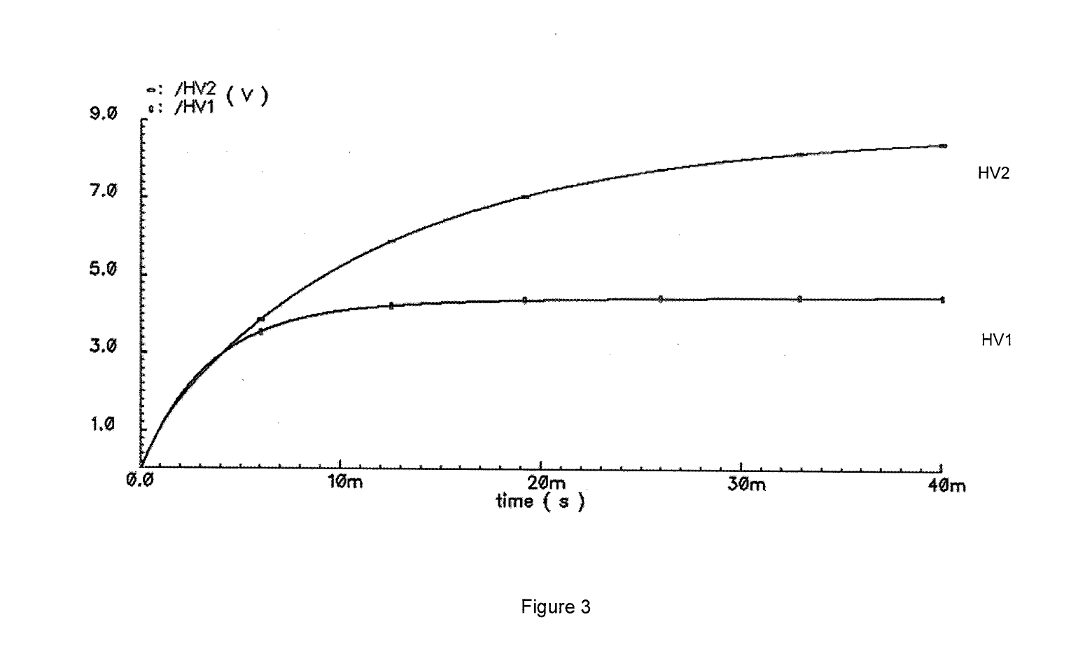

A comparison of the waveform of the voltage CHV2 with and without the exemplary charge pump circuit is as shown in FIG. 3. In order to obtain good efficiency, the voltage drop across all diodes must be minimized Schottky diodes may be used to improve the efficiency of charge pump circuit 108. Referring again to FIG. 2b, the right half of charge-pump circuit 108 is the same as the left half except the signals RF1 and RF2 are swapped. The diodes D3, D4 and the capacitor CPMP2 operate the same way as the diodes D1, D2 and the capacitor CPMP1 respectively. Therefore the left and the right halves of the charge-pump circuit operate on opposite phase of each other.

Hence, as shown in FIG. 3, at the same simulation condition (i.e., with the reader and the transponder both having the same coil inductance and coupling factor), the voltage at storage capacitor C_{HV2} (which is at, for example, around 8 V) can go to a level approximately 2 times higher than the voltage at C_{HV1} (which is at, for example around 4V) whereas the maximum voltage of the signals VRF1 and VRF2 are at, for example around 4 V. As such, for any given voltage VRF1 and VFR2, VHV2 will be approximately 2 times higher. The frequency used in this simulation is 134.2 kHz with the capacitance of CPMP1, CPMP2, and CHV2 being equal to 20 pF, 20 pF, and 15 nF, respectively. In other embodiments, the capacitance of CPMP1 and CPMP2 may be adjusted to other values without affecting the performance of the charge-pump circuit.

Typically, the length of the interrogation period of the RFID reader 150 is chosen such that it coincides with the optimal charge time of storage capacitor 110 in HDX transponder 100. This means that at the end of an interrogation field, the storage capacitor 110 will be charged up to about 80-90% of the maximum value achievable when the tuned circuit reaches the steady state. However, the transponder requires an appropriate amount of energy to be able to transmit an entire response data. Therefore, the threshold level of the voltage on storage capacitor 110 is defined such that transponder 100 only responds when the stored voltage VHV at the end of the interrogation period is more than a pre-defined voltage threshold level.

This voltage threshold level is also called the high-voltage ready level. If the steady state value of the stored voltage is lower than the voltage threshold level, which could occur when the transponder is too far from the RFID reader; the transponder 100 cannot respond to RFID reader 150 no matter how long the interrogation period of RFID reader 150 is. This is due to the fact that as long as the transponder stays at that distance, the stored voltage isn't sufficient to transmit with adequate power and the transmission will end up being incomplete. However, by using charge-pump circuit 108 and by utilizing multi-cycle charging as described below, this will allow more energy to be charged to the storage capacitor 110 thereby raising the steady state level of the stored voltage VHV.

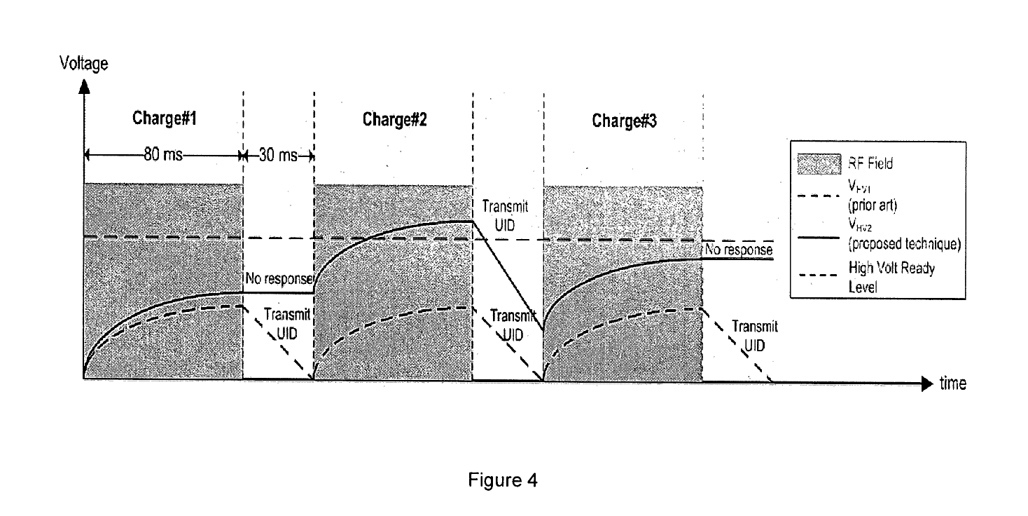

FIG. 4 depicts an embodiment of how charge-pump circuit 108 may be used to increase the stored voltage VHV when it is under the high-voltage ready threshold after the first interrogation period. In this embodiment, in order to preserve the stored voltage VHV2, transponder 100 will not start transmitting the response until the next interrogation period when the charge-pump circuit will be enabled. A high-voltage threshold detector (not shown) may be used to instruct the transponder to skip the transmission if the stored voltage on the storage capacitor doesn't get above the pre-defined threshold.

After the second interrogation period, when the stored voltage VHV2 becomes higher than the threshold level, then transponder 100 will begin the transmission. In essence, transponder 100 may wait for at least two interrogation cycles to store energy before it responds to RFID reader 150. After the transmission, the stored energy will be depleted and charge-pump circuit 108 will be turned off. Transponder 100 will restart charging without the help of charge-pump circuit 108 in the next interrogation period and check whether or not the stored voltage is higher than the high-voltage ready threshold by comparing the stored voltage to the pre-defined voltage threshold at the end of the interrogation period.

If the stored value is lower than the high-voltage ready threshold, the transponder will wait for another interrogation period before enabling the charge-pump circuit 108. This will cause the stored voltage VHV2 to increase in the following interrogation period. At the end of the following interrogation period, the stored voltage VHV2 could be higher than the high-voltage ready threshold, in which case, the transponder 100 will begin transmission.

It is also possible to achieve an even higher voltage level by charging with a pre-defined number of successive interrogation cycles with the charge-pump circuit turned on. With this method, it is not significant if the RFID reader 150 has a short interrogation period because the transponder 100 can wait and collect energy across multiple cycles as shown in FIG. 4. The number of charging cycles can be made adaptive by comparing the stored voltage to the high-voltage ready threshold and transmitting the response right after the cycle which has the stored voltage surpassing the threshold level.

The charge-pump circuit example in FIG. 2b can ideally multiply the input voltage by two times and this is called a single stage charge-pump circuit. To achieve a higher voltage for the stored capacitor, one or more stages of the charge-pump circuit may be cascaded by connecting outputs of the previous stage as inputs for the next stage. In this way, the input voltage is multiplied by the number of stages plus one. For example, with a 3-stage charge-pump circuit, the input voltage will be multiplied by 4 times. However, from experimentation, in most scenarios, using a single-stage charge-pump circuit will give sufficient stored voltage as the read distance may be increased by about 10-30%. As such, a 3-stage charge-pump may not be necessary as it may require too long a charging time for certain scenarios.

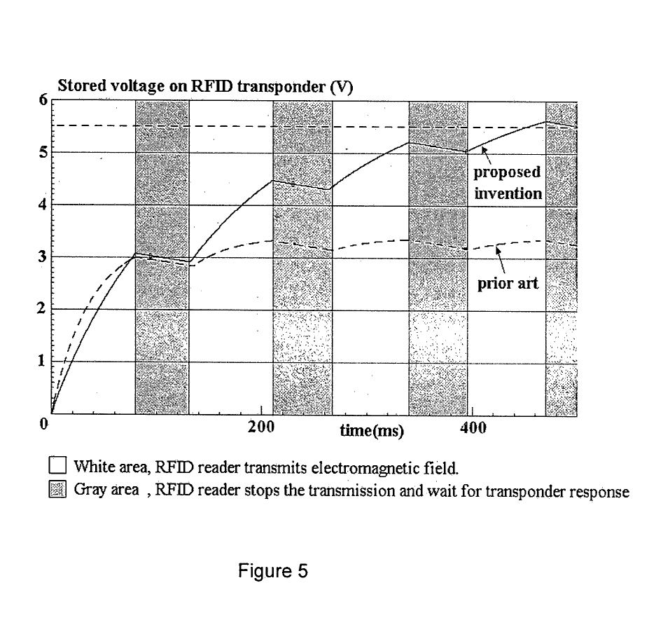

FIG. 5 shows simulated waveforms comparing the voltage across a storage capacitor with or without the exemplary charge-pump circuit after 4 charging cycles. As can be seen, with the use of the exemplary charge-pump circuit, the stored voltage of the transponder can increase with each cycle thereby increasing the read distance. Although only 4 charging cycles is shown, additional charging cycles and/or additional charge-pump stages may be employed to further enhance the read distance.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A transponder having improved read range comprising:
an antenna for receiving energy from an interrogation signal;
a resonant capacitor coupling with the antenna to form a tuned circuit;
a rectifying device for extracting usable positive voltage from the tuned circuit;
a charge-pump circuit for multiplying the usable positive voltage derived from the output of the rectifying device; and
a storage capacitor for storing energy from the voltage which has been multiplied by the charge-pump circuit.

2. The transponder of claim 1 further comprising:
an end-of-burst detector which detects the time when an interrogation period ends;
an oscillator which generates carrier frequency for data transmission back to a reader once the interrogation period ends;
a modulation control circuit which encodes data to be transmitted and controls how the oscillator modulates the response signal; and
a memory which holds identification data.

3. The transponder of claim 1 wherein the rectifying device is composed of two pairs of complementary transistors.

4. The transponder of claim 1 wherein the charge-pump circuit comprises a first diode with its anode connected to an input and an output connected to a pump capacitor having a driving signal of opposite phase to the input and a second diode connected in series with the first diode having the storage capacitor at its cathode.

5. The transponder of claim 4 wherein the diodes in the charge-pump circuit comprises Schottky type diodes.

6. The transponder of claim 1 wherein the charge-pump circuit is either single stage or multiple stage.

7. The transponder of claim 2 further comprising a high-voltage threshold detector which will instruct the transponder to skip the transmission if the stored voltage on the storage capacitor doesn't get above a pre-defined threshold.

8. The transponder of claim 2 wherein the transponder waits for at least two interrogation cycles to store energy before it responses to the RFID reader.

9. A transponder comprising:
an antenna for receiving energy from an interrogation signal;
a resonant capacitor coupling with the antenna to form a tuned circuit;
a charge pump circuit for multiplying voltage derived directly from the tuned circuit; and
a storage capacitor for storing energy from the voltage which has been multiplied by the charge-pump circuit.

10. The transponder of claim 9 further comprising a rectifying device for extracting usable positive voltage from the tuned circuit, wherein the charge-pump circuit multiplies the usable positive voltage derived from the output of the rectifying device.

11. The transponder of claim 9 wherein the rectifying device is composed of two pairs of complementary transistors.

12. The transponder of claim 9 wherein the charge-pump circuit comprises a first diode with its anode connected to an input and an output connected to a pump capacitor having a driving signal of opposite phase to the input and a second diode connected in series with the first diode having the storage capacitor at its cathode.

13. The transponder of claim 9 wherein the charge-pump circuit is either single stage or multiple stage.

14. A method of improving HDX transponder read distance comprising the steps of:
receiving an interrogation signal by an antenna;
multiplying the interrogation signal received from the antenna with a charge pump circuit;
storing the multiplied voltage in a storage capacitor;
detecting the end of interrogation signal; and
transmitting data to the reader using an oscillator powered by the stored multiplied voltage.

15. The method of claim 14 wherein multiplying the interrogation signal further comprises the steps of rectifying the interrogation signal into a usable positive voltage and multiplying the usable positive voltage with the charge pump circuit.

16. The method of claim 14 further comprising the step of skipping transmission of the data after the first interrogation signal ends for at least 1 cycle to get higher voltage in the storage capacitor for higher transmission power.

17. The method of claim 14 further comprising the steps of:
comparing the stored multiplied voltage to a pre-defined voltage threshold after the interrogation signal ends; and
skipping transmission of the data if the stored multiplied voltage is lower than the pre-defined voltage threshold.

18. The method of claim 15 further comprising the step of skipping transmission of the data after the first interrogation signal ends for at least 1 cycle to get higher voltage in the storage capacitor for higher transmission power.

19. The method of claim 15 further comprising the steps of:
comparing the stored multiplied voltage to a pre-defined voltage threshold after the interrogation signal ends; and
skipping transmission of the data if the stored multiplied voltage is lower than the pre-defined voltage threshold.

20. The method of claim 14 further comprising the step of waiting for at least two interrogation cycles before transmitting data to the reader.
